(19) United States
(12) Patent Application Publication
(10) Pub. No.: US 2018/0195946 A1
(43) Pub. Date: Jul. 12, 2018

(54) DUST SENSOR HAVING FLOW RATE CONTROL FUNCTION

(71) Applicants: Hyundai Motor Company, Seoul (KR); Kia Motors Corporation, Seoul (KR); HANON SYSTEMS, Daejeon (KR); DOOWON CLIMATE CONTROL CO., LTD., Asan-si (KR); ONEGENE ELECTRONICS, Hwaseong-si (KR); TRUWIN, Daejeon (KR)

(72) Inventors: Dong Ho KWON, Bonghwa-eup (KR); Gee Young SHIN, Suwon-si (KR); Myung Hoe KIM, Seoul (KR); Dong Won YEON, Hwaseong-si (KR); Moo Yong KIM, Suwon-si (KR); Chae Geun LIM, Daejeon (KR); Sang Ho OH, Daejeon (KR); Joong Heum JUNG, Daejeon (KR); Hyun Hoo JANG, Asan-si (KR); Young Oh KIM, Seongnam-si (KR); Do Yeop KANG, Pyeongtaek-si (KR); Jin Young LEE, Hwaseong-si (KR); Jung Keun PARK, Daejeon (KR); Du Yeol KIM, Daejeon (KR)

(73) Assignees: Hyundai Motor Company, Seoul (KR); Kia Motors Corporation, Seoul (KR); HANON SYSTEMS, Daejeon (KR); DOOWON CLIMATE CONTROL CO., LTD., Asan-si (KR); ONEGENE ELECTRONICS, Hwaseong-si (KR); TRUWIN, Daejeon (KR)

(21) Appl. No.: 15/842,643

(22) Filed: Dec. 14, 2017

(30) Foreign Application Priority Data
Jan. 10, 2017 (KR) 10-2017-0003298

(51) Int. Cl. G01N 15/06

(52) U.S. Cl. CPC G01N 15/06; B60H 1/008; G01N 2015/0693

(57) ABSTRACT

A dust sensor apparatus having flow rate control function for securing reliability of measurement of the dust sensor by constantly maintaining flow rate of the air flowing into the dust sensor for measuring concentration of dust in the internal of a vehicle, may include a blow motor configured for controlling flow rate of the air to be packaged in the dust sensor for measuring concentration of dust in the internal of a vehicle such that flow rate of the air flowing into the dust sensor is maintained constantly.

### CROSS-REFERENCE(S) TO RELATED APPLICATION

The present application claims priority to Korean Patent Application No. 10-2017-0003298 filed on Jan. 10, 2017, the entire contents of which are incorporated herein for all purposes by this reference.

### BACKGROUND OF THE INVENTION

### Field of the Invention

The present invention relates to a dust sensor having flow rate control function, and more particularly, to a dust sensor having flow rate control function for securing reliability of measurement of the dust sensor by maintaining constant flow rate of the air flowing into the dust sensor for measuring concentration of dust in the interior of a vehicle.

### Description of Related art

Generally, an automotive air conditioning system is configured to introduce the indoor and outdoor air of a vehicle, cool or heat the introduced air and then blows the cooled or heated air into the vehicle, thereby heating or cooling the interior of the vehicle. This air conditioning system is provided with a filter for filtering foreign materials in the air to be blown into the vehicle.

However, there is a limit in filtering the whole foreign materials in the air by utilizing the filter. Particularly, when concentration of dust in the air outside the vehicle is high, there is a fear that a large amount of dust may be introduced inside the vehicle due to limitation of filtration performance.

Recently, various researches have been conducted on a technique for measuring dust inside the vehicle to keep quality of the air inside the vehicle comfortable.

Korean Laid-Open Patent Publication No. 10-2015-0096845 discloses a technique for measuring dust in the interior of a vehicle by utilizing a dust sensor to manage cleanliness condition of the air inside the vehicle.

When contamination of the air inside the vehicle is managed by using measured values of the dust sensor, reliability of measurement of the dust sensor must be secured. Nevertheless, there is a problem in the related art in that flow rate of the air is not maintained constantly but fluctuates when the air is introduced into the dust sensor to measure dust and hence reliability of measurement of the dust sensor is lowered.

The information disclosed in this Background of the Invention section is for enhancement of understanding of the general background of the invention and is/are configured to not be taken as an acknowledgement or a form of suggestion that this information forms the prior art already known to a person skilled in the art.

### BRIEF SUMMARY

Various aspects of the present invention are directed to providing a dust sensor having flow rate control function for securing reliability of measurement of the dust sensor by including a blow motor configured for controlling flow rate of the air to be packaged in the dust sensor for measuring concentration of dust inside a vehicle such that flow rate of the air flowing into the dust sensor is maintained constantly.

Various aspects of the present invention are directed to providing a dust sensor having flow rate control function for securing reliability of measurement of the dust sensor by introducing flow of the air in a curved form through a flow path through which the air flowing into the dust sensor moves to moderate change in the flow rate of the air such that even when sudden change in flow rate of the outside air occurs, uniform and stable flow rate of the air can be secured.

In one aspect of the present invention, a dust sensor having flow rate control function including: a case having an air inlet portion through which the air for measurement of concentration of dust flows into the case; an air flow path for guiding flow of the air introduced into the case through the air inlet portion; and a blow motor configured for controlling flow rate of the air flowing into the air flow path to a constant level.

According to an exemplary embodiment of the present invention, the air flow path includes an illumination area to be irradiated with light for measuring concentration of dust, wherein the blow motor is mounted at a downstream side of the air flow path on the basis of the illumination area to draw the air to be introduced therein through the air inlet portion and then discharge the air to the outside of the case.

In the instant case, the blow motor includes an impeller for causing air flow by its rotational motion and a casing in which the impeller is rotatably disposed, wherein the casing includes an internal flow path connected to the air flow path and the internal flow path is formed to have a larger diameter than that of the air flow path.

Further, the casing is provided with a discharge port through which the air introduced into the internal flow path is discharged, wherein the discharge port is formed on an external circumferential surface of the casing so as not to be positioned on the same line as a longitudinal direction of the internal flow path.

Further, a plurality of partition walls spaced apart in the longitudinal direction of the air flow path are formed at an upstream side of the air flow path on the basis of the illumination area, wherein the plurality of partition walls are formed such that one of the partition walls and the other partition wall closest to the one partition wall protrude toward each other from opposite sides and each of the partition walls is formed to shield at least one-half of the cross section of the air flow path.

According to another exemplary embodiment of the present invention, the air flow path includes an illumination area to be irradiated with light for measuring concentration of dust, wherein the blow motor is mounted at an upstream side of the air flow path on the basis of the illumination area to draw the air to be introduced therein through the air inlet portion and then discharge the air to the illumination area.

In the instant case, the air flow path includes a front flow path connected to the air inlet portion and a rear flow path which is connected to the front flow path and includes the illumination area, wherein the front flow path and the rear flow path are formed to guide the air flow in different directions respectively so that flow direction of the air introduced therein through the air inlet portion is changed at least once in the air flow path.

The front flow path and the rear flow path are connected to each other to have a predetermined included angle therebetween on the basis of longitudinal directions of the front and rear flow paths.

Further, the air inlet portion is formed in a shape of a pipe protruding from one surface of the case to the outside of the case and the blow motor is mounted at the upstream side of the front flow path connected to the downstream side of the air inlet portion. In the instant case, the front flow path is formed such that an area at the downstream side of the front flow path on the basis of the position where the blow motor is mounted is inclined with respect to the longitudinal direction of the air inlet portion, the rear flow path is formed such that an air discharge portion is formed at the downstream side of the rear flow path on the basis of the illumination area, and the rear flow path and the air discharge portion have a predetermined included angle on the basis of the longitudinal direction of the rear flow path and an axial direction of the air discharge portion.

With the dust sensor having flow rate control function according to an exemplary embodiment of the present invention, it is possible to secure reliability of measurement of the dust sensor by utilizing the blow motor to maintain flow rate of the air flowing into the dust sensor constantly and stabilize the flow rate. Further, it is possible to secure stability of flow rate of the air flowing into the dust sensor even when sudden change in flow rate of the outside air occurs by introducing flow of the air in a curved form through the configuration of the flow path resulting from a coupling structure between the dust sensor and the blow motor.

Other aspects and exemplary embodiments of the invention are discussed infra.

It is understood that the term “vehicle” or “vehicular” or other similar term as used herein is inclusive of motor vehicles in general including passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

The above and other features of the invention are discussed infra.

### BRIEF DESCRIPTION OF THE DRAWINGS

FIG. 1 is a view showing a configuration of a dust sensor having flow rate control function, according to an exemplary embodiment of the present invention;

FIG. 2 is a view showing the inside of a blow motor mounted in a dust sensor according to an exemplary embodiment of the present invention;

FIG. 3 is an external perspective view of a dust sensor according to another exemplary embodiment of the present invention;

FIG. 4 is a cross section view taken from a portion A of FIG. 3;

FIG. 5 is a top plan view showing the inside of a dust sensor according to another exemplary embodiment of the present invention; and

FIG. 6A and FIG. 6B show graphs each of which indicates comparison of performance of measurement before mounting a blow motor in a dust sensor with that after mounting the blow motor in the dust sensor.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not the exemplary embodiments, but also various alternatives, modifications, equivalents and other embodiments, which is/are configured to be included within the spirit and scope of the invention as defined by the appended claims.

When flow rate of the air inside vehicle is unstable, for example, when the vehicle is running with a window opened, flow rate of the air around a dust sensor for measuring concentration of dust inside the vehicle becomes uneven and as a result the air flowing into the dust sensor also flows at a non-uniform flow rate.

When flow rate of the air flowing into the dust sensor is uneven as mentioned above, performance of detecting dust suspended in the air deteriorates and hence it is difficult to secure reliability of measurement.

In general, an optical sensor is mainly used as a dust sensor for measuring concentration of dust contained in the air. A light scattering type dust sensor for detecting amount of light scattered by dust in the air is known.

The light scattering type dust sensor is provided with a light source device including a light emitting element including a light emitting diode, a light receiving device including a light receiving element including a photodiode, and a lens for condensing light scattered by dust particles in the air.

In such a dust sensor, when the light emitting element irradiates light to an illumination area inside the case of the sensor, the light is scattered by particles, that is, dust particles in the air introduced into the sensor case. At this time, intensity (or amount) of the scattered light is proportional to concentration of the dust particles in the air.

The dust sensor in turn condenses the light scattered by the dust particles in the air, using a condenser lens. Then the light receiving element receives the condensed light and outputs electrical signals corresponding to the concentration of the dust.

However, when the flow rate of the air flowing into the dust sensor is not constant but non-uniform, there is a problem that reliability of measurement of the concentration of the dust detected through the light scattering method is lowered.

Thus, various embodiments of the present invention relates to controlling flow rate of the air flowing into the dust sensor to a constant level regardless of change in flow rate of the outside air generated around the dust sensor to secure reliability of measurement of the concentration of the dust.

To this end, the present invention includes a blow motor at one side of an air flow path in a dust sensor to control flow rate of the air flowing into an air inlet portion of the dust sensor such that even when change in flow rate of the outside air occurs, flow rate of the air flowing into the dust sensor is maintained constantly.

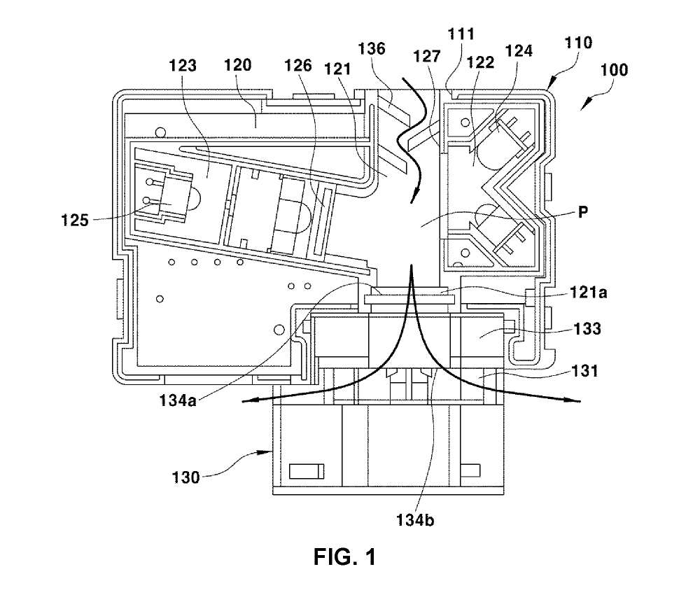

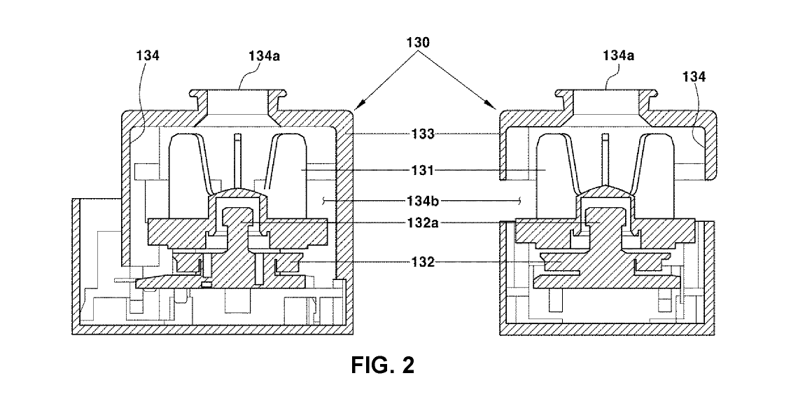

FIG. 1 of the appended drawings is a view showing a configuration of a dust sensor having flow rate control function, according to an exemplary embodiment of the present invention and FIG. 2 is a view showing the inside of a blow motor mounted in the dust sensor.

As shown in FIG. 1, a dust sensor 100 according to an exemplary embodiment of the present invention may include a case 110 having an internal space of which one side is opened; and an internal case 120 disposed in the internal space of the case 110 and provided with an air flow path 121 through which the air in which dust is suspended passes and optical paths 122, 123 through which light passes.

Although not shown in the drawings, a case cover is assembled with the case 110 to cover one open side of the internal space, wherein the case cover assembled with the case 110 encloses and forms the air flow path 121 and the optical paths 122, 123 along with the internal case 120 disposed within the internal space of the case 110.

Components of the sensor for measuring concentration of dust including a light emitting element 124, a light receiving element 125 and a condenser lens 126, are disposed in the internal case 120. The internal case includes a straight air guide portion 127 which encloses and forms one side of the air flow path 121 and it also encloses the other side of the air flow path 121 when the case cover is assembled to the case 110.

The air flow path 121 is formed as a single straight flow path for guiding flow of the air introduced into the case 110. A portion crossing flow direction of the air passing through the air flow path 121 (or longitudinal direction of the air flow path), i.e., a cross section of the air flow path is kept constant. For example, a circular cross-sectional shape is kept constant in the flow direction of the air.

The case 110 includes an air inlet portion 111 through which the air and dust particles suspended in the air is introduced into the casing, wherein the air inlet portion 111 is adjacent and connected to an upstream end portion of the air flow path 121.

Accordingly, the air introduced into the case 110 through the air inlet portion 111 passes through the air flow path 121 and is discharged to the outside of the case 110. At this time, dust particles suspended in the air is irradiated with light emitted from the light emitting element 124 when the dust particles pass through an illumination area P in the air flow path 121.

Light emitted from the light emitting element 124 passes through a first optical path 122 and is irradiated to the illumination area P, while light which is scattered in the illumination area P by the dust particles contained in the air passes through a second optical path 123 and is received by the light receiving element 125.

The illumination area P is an area which is irradiated with light emitted from the light emitting element 124 to measure concentration of dust and set at the middle area of the air flow path 121 in a longitudinal direction of the air flow path. A blow motor 130 is disposed at a downstream side of the air flow path 121 on the basis of the illumination area P set at the middle of the air flow path 121.

As shown in FIG. 1 and FIG. 2, the blow motor 130 controls flow rate of the air flowing through the air flow path 121 and includes an impeller 131 for causing flow of the air by its rotational motion and a casing 133 to which the impeller 131 is disposed to receive rotational power and hence rotate.

The impeller 131 is co-rotatably coupled to a rotation shaft 132a of a driving device 132 for supplying rotational power and is rotated when the rotation shaft 132a rotates, forcing the air introduced into the air flow path 121 by the rotational motion to flow at a uniform flow rate.

The casing 133 is formed into a structure surrounding the impeller 131 in a circumferential direction wherein a suction port 134a directly connected to a downstream end portion of the air flow path 121 (i.e., air discharge portion) is formed at a front end portion of the casing 133 and a discharge port 134b through which the air introduced through the suction port 134a is discharged is formed at a rear end portion of the casing 133.

In other words, the casing 133 is provided with an internal flow path 134 connected to the air flow path 121 between the suction port 134a and the discharge port 134b, wherein the internal path 134 is configured to guide flow of the air passing through the periphery of the impeller 131.

One end portion of the internal flow path 134 is the suction port 134a and the other end portion thereof is the discharge port 134b. The casing 133 has a structure that airtightly surrounds the impeller 131 rotatably disposed in the internal flow path 134 having the suction port 134a and the discharge port 134b.

The casing 133 is fastened and fixed to the case 110 such that the suction port 134a is hermetically connected to the air discharge portion 121a of the air flow path 121. In the instant case, the driving device 132 disposed in the casing 133 and a portion of the casing 133, which surrounds the driving device 132, are protruded to the outside of the case 110.

The blow motor 130 draws the air flowing through the air inlet portion 111 of the case 110 and discharges the air to the outside of the case 110 when the impeller 131 rotates. At this time, the air introduced into the suction port 134a of the casing 133 passes through the internal flow path 134 and is discharged to the outside of the casing 133 through the discharge port 134b.

With the blow motor 130 mounted at the downstream side of the illumination area P within the air flow path 121, flow rate of the air in the air flow path 121 is controlled uniformly and then stabilized and flow rate in the illumination area P for measuring concentration of dust is stabilized so that constant flow rate of the air is secured and hence reliability of measurement of the dust sensor 100 is secured.

In the case where a sudden change in the flow rate occurs due to a sudden change in the flow rate of the air outside the dust sensor 100, the air flowing into the case 110 through the air inlet portion 111 is also introduced with a sudden change in the flow rate.

Accordingly, to cope with such a sudden change in the flow rate of the outside air, the internal flow path 134 is formed such that diameter of the discharge port 134b is greater than that of the suction port 134a.

As shown in FIG. 2, the internal path 134 is formed to have a larger diameter by a predetermined size than diameter of the air flow path 121 of the case 110.

Therefore, the air passing through the internal passage 134 via the air flow path 121 forms straight flow along the air flow path 121 in the case 110, and then flows while spreading as the diameter of the flow path increases when passing through the internal path 134 in the casing 133, forming curved flow.

That is, the air introduced into the case 110 through the air inlet portion 111 is guided in a form of straight flow by the air flow path 121 and then flows into a form of curved flow as radius of flow changes in the internal flow path 134 of the casing 133, so that change in the flow rate of the air is moderated and hence stability of the flow rate is secured and performance of controlling flow rate of the blow motor 130 can be assisted.

In other words, since the air flowing through the air flow path 121 and the internal flow path 134 flows into a form of curved flow due to difference between diameters of the air passage 121 and the internal passage 134, buffer effect for the change in the flow rate of the air outside the case 110 is secured so that the flow rate of the air flowing into the case 110 and flowing into the air flow path 121 can be further stabilized. As a result, even when sudden change in the flow rate of the outside air occurs, constant flow rate of the air can be secured by utilizing the blow motor 130.

Further, as mentioned above, the casing 133 of the blow motor 130 includes the discharge port 134b for discharging the air introduced into the internal flow path 134 through the suction port 134a of the casing 133 to the outside of the casing 133, wherein the discharge port 134b is formed on the external circumferential surface of the casing 133 so as not to be positioned on the same line as the longitudinal direction of the internal flow path 134. As an example, the discharge port 134b is formed to be perpendicular to the internal flow path 134 of the casing 133 and the air flow path 121 of the case 110.

The discharge port 134b is formed on the external circumferential surface of the casing 133 so as not to be positioned on the same line as the longitudinal direction of the internal flow path 134 and hence it forms a predetermined included angle with the air flow path 121. The discharge port 134b (precisely, the plane in which the discharge port 134b exists) forms a contained angle of a right angle, or an obtuse or acute angle close to a right angle with respect to the longitudinal direction of the air flow path 121.

In other words, the discharge port 134b is formed on the external circumferential surface of the casing 133 so as not to be positioned on the same line as the suction port 134a connected to the air flow path 121 such that flow direction of the air introduced into the internal flow path 134 through the suction port 134a is changed to be bent (or curved) around the discharge port 134b.

Since the discharge port 134b is disposed outside the case 110 in a state that the blow motor 130 is mounted in the case 110 of the dust sensor 100, the air passing through the internal flow path 134 is discharged to the outside of the casing 133 and the case 110 through the discharge port 134b. At this time, since the discharge port 134b is not positioned on the same line as the longitudinal direction of the air flow path 121 and the internal flow path 134 but is formed at a position where it forms a contained angle of a right angle or an angle close to a right angle with respect to the longitudinal direction of the air flow path and the internal flow path, the discharge port 134b allows the air passing through the internal flow path 134 to be curved at a larger curvature to form curved flow.

Further, a plurality of partition walls 136 spaced apart in the longitudinal direction of the air flow path 121 are formed at the upstream side of the air flow path 121, the upstream side of the air flow path 121 on the basis of the illumination area P wherein the plurality of partition walls 136 are formed into a shape protruding from the air guide portion 127 surrounding the air path flow 121.

The plurality of partition walls 136 are configured such that one partition wall and the other partition wall closest to the one partition wall protrude from the air guide 127 toward each other from opposite sides and that each of the partition walls 136 is formed to shield at least one-half of the cross section of the air flow path 121 (the cross section is taken by cutting the air flow path 121 in a direction crossing the longitudinal direction of the air flow path).

Further, each of the partition walls 136 is formed in a shape inclined obliquely with respect to the longitudinal direction of the air flow path 121. In the instant case, each partition wall is formed in a structure inclined to extend toward the downstream side of the air flow path 121, and as a result, a staggered flow path is formed at the upstream side of a straight air flow path of the air flow path 121 so that the air introduced into the air flow path 121 flows into a substantially S-curved shape at the upstream side of the air flow path 121.

That is, the plurality of partition walls 136 are formed to protrude from the air guide portion 127 in a staggered structure and disposed at a predetermined interval in the air flow path 121 so that the air flowing into the case 110 through the air inlet portion 111 forms curved flow at the upstream side of the air flow path 121.

Accordingly, the air introduced into the case 110 through the air inlet portion 111 passes over the plurality of partition walls 136 and is guided to the illumination area P by the air flow path 121. Subsequently, the air passes through the internal flow path 134 of the casing 133 and flows toward the discharge port 134b and then it is discharged to the outside of the blow motor 130 and the dust sensor 100 through the discharge port 134b, with the result that the air flows into a curved form due to such movement paths.

As mentioned above, the discharge port 134b provided at the end portion of the internal flow path 134 is formed on the external circumferential surface of the casing 133 so as not to be positioned on the same line as the longitudinal direction of the internal flow path 134 so that flow of the air passing through the air flow path 121 and the internal flow path 134 flows is curved with a larger curvature. Further, a plurality of partition walls 136 are further provided on the upstream side of the air flow path 121 so that a flow path for guiding curved flow (that is, a curved flow path) is formed at the upstream side of the air flow path 121, with the result that the air which is introduced through the air inlet portion 111 of the dust sensor 100 and then discharged to the outside through the blow motor 130 forms more complex curved flow.

Therefore, even when the outside air having sudden change in its flow rate is introduced into the dust sensor 100 through the air inlet portion 111, such sudden change in the flow rate can be moderated, and as a result, the flow rate control performance of the blower motor 130 can be secured more stably.

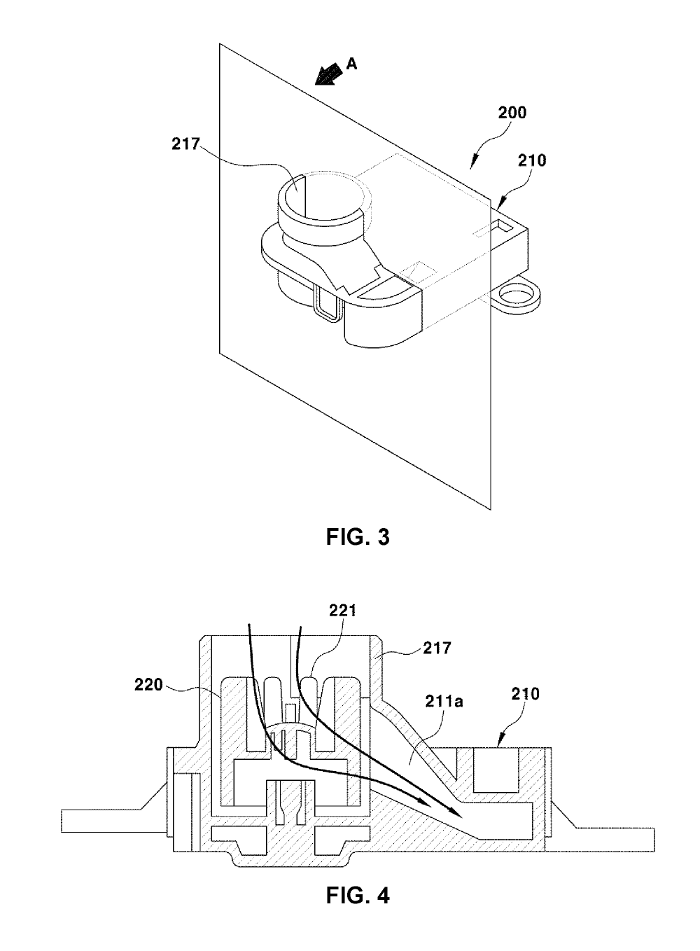

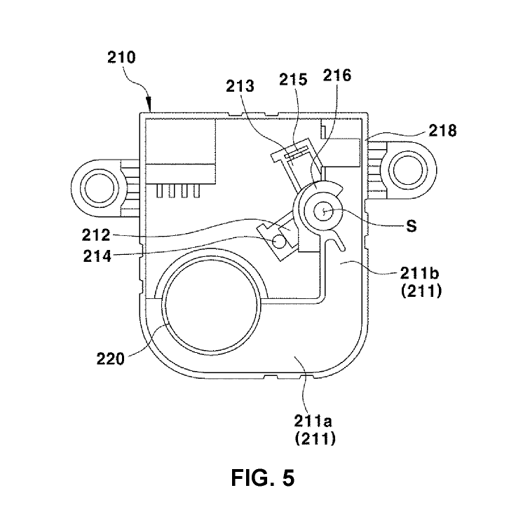

FIG. 3 is an external perspective view of a dust sensor according to another exemplary embodiment of the present invention, FIG. 4 is a cross section view taken from a section A of FIG. 3 and FIG. 5 is a top plan view showing the inside of the dust sensor.

Here, description similar to or redundant with that about the dust sensor according to one exemplary embodiment of the present invention as discussed above may be omitted.

As shown in FIG. 3, FIG. 4, and FIG. 5, a dust sensor 200 according to another exemplary embodiment of the present invention includes a case 210 having an air inlet portion 217 through which the air for measurement of concentration of dust flows into the case; an air flow path 211 for guiding flow of the air introduced into the case 210 through the air inlet portion 217; and a blow motor 220 for controlling flow rate of the air flowing into the air flow path 211 to a constant level.

A space through which the air containing dust passes and flows is partitioned separately in the case 210. This space becomes the air flow path 211. Further, a first optical path 212 and a second optical path 213 are separately defined as a space through which light emitted from a light emitting element 214 passes and a space through which light received by a light receiving element 215 passes, respectively.

As shown in FIG. 4 and FIG. 5, the air flow path 211 is formed in an approximate L-shaped flow path and has an illumination area S to be irradiated with light emitted from the light emitting element 214.

The air flow path 211 includes a front flow path 211a in a straight form, which is connected to the air inlet portion 217, and a rear flow path 211b in a straight form, which is connected to an air discharge portion 218. The rear flow path 211b connected to a downstream end portion of the front flow path 211a and is configured to turn and change direction of guiding the air by approximately 90 degrees at the downstream end portion of the front flow path 211a. Accordingly, as the front flow path 211a and the rear flow path 211b are disposed in different directions (precisely, directions orthogonal to each other) to guide flow of the air, flow direction of the air introduced through the air inlet portion 217 is curved and changed at a portion where the front flow path 211a and the rear flow path 211b are connected (i.e. at the middle portion where the air flow path 211 is bent).

That is, the front flow path 211a and the rear flow path 211b form a predetermined contained angle (e.g., a contained angle of 90° or approximate 90°) on the basis of longitudinal directions of the front flow path 211a and the rear flow path 211b.

Therefore, the air introduced into the case 210 through the air inlet portion 217 flows into a curved form while changing its flow direction at least once at the middle of the air flow path 211 before the air is discharged to the outside of the case 210 through the air outlet portion 218.

An illumination area S is set at an area located at the middle of the rear flow path 211b in the longitudinal direction of the rear flow path.

The illumination area S is an area which is irradiated with light emitted from the light emitting element 214 to measure concentration of dust and set at the middle area of the rear air flow path 211b. The light of the light emitting element 214 that has passed through the first optical path 212 and is irradiated to the illumination area S is scattered by dust particles in the air. At this time, the scattered light is condensed by a condenser lens 216 disposed on the upstream side of the second optical path 213 and then received by the light receiving element 215 disposed on the downstream side of the second optical path 213.

The front flow path 211a is disposed at and connected to an upstream end portion of the rear flow path 211b on the basis of the illumination area S and the air outlet portion 218 is disposed at a downstream side of the rear flow path 211b so that the air passed through the front flow path 211a and the illumination area S is discharged to the outside of the case 210 through the air outlet portion 218.

A blow motor 220 is mounted at the upstream side of the air flow path 211 on the basis of the illumination area S. This blow motor 220 draws the air flowing into the case 210 through the air inlet portion 217 and discharges the air to the illumination area S.

The blow motor 220 is disposed in the front flow path 211a connected to the upstream side of the flow path 211 and the upstream side of the rear flow path 211b. The blow motor is mounted at the upstream side close to the air inlet portion 217 out of the front flow path 211a (i.e., upstream side of the front flow path 211a).

The blow motor 220 is configured to cause flow of the air through rotational motion of the impeller 221 and disposed between the air inlet portion 217 and the illumination area S, drawing the air introduced into the case 210 through the air inlet portion 217 and discharging at a constant flow rate.

The air inlet portion 217 is formed in a shape of a pipe protruding from one side surface of the case 210 to the outside of the case 210. The blow motor 220 is disposed below the air inlet portion 217.

That is, the blow motor 220 is disposed at the upstream side of the front flow path 211a connected to the air inlet portion 217 and housed in the case 210 in a state of being positioned below the air inlet portion 217. In other words, the blow motor 220 is mounted at the upstream end portion of the front flow path 211a connected to the downstream end portion of the air inlet portion 217.

In addition, the front flow path 211a is formed such that at least a portion of the front flow path 211a is inclined obliquely with respect to the longitudinal direction of the air inlet portion 217. The front flow path 211a is formed such that an area at the downstream side of the front flow path 211a is inclined with respect to the longitudinal direction of the air inlet portion 217 on the basis of the position where the blow motor 220 is mounted.

The air inlet portion 217 and the front flow path 211a are disposed in different directions from each other on the basis of the blow motor 220 to guide flow of the air, that is, a contained angle of a predetermined acute or obtuse angle exists between the air inlet portion 217 and the front flow path 211a on the basis of the blow motor 220, so that when the air passed through the air inlet portion 217 is discharged to the front flow path 211a through the blow motor 220, flow direction of the air is changed.

That is, as the air inlet portion 217 and the front flow path 211a form a curved flow path, the air introduced into the air inlet portion 217 and then guided through the front flow path 211a flows while it is curved in a curved form.

Further, the rear flow path 211b is formed such that the air outlet portion 218 disposed at the downstream side of the rear flow path 211b on the basis of the illumination area S is formed on a wall surface of the case 210 surrounding one side of the rear flow path 211b along the longitudinal direction of the rear flow path 211b, so that flow direction of the air flowing along the rear flow path 211b is changed at the air outlet portion 218.

That is, the air outlet portion 218 is formed at a position where it can change flow direction of the air to be guided linearly along the rear flow path 211b and as a result the rear flow path 211b and the air outlet portion 218 form a flow path for guiding the air in a curved form, i.e., a curved flow path.

The dust sensor 200 constructed as described above is formed such that the front flow path 211a and the rear flow path 211b form a contained angle of a predetermined size (e.g., a contained angle of 90° or approximate 90°) so that the air introduced into the case 210 through the air inlet portion 217 flows into a curved form while its flow direction is changed at least once at the middle of the flow path. Therefore, change in the flow rate of the air introduced in the dust sensor through the air inlet portion 217 is moderated and hence stability of flow rate of the air is secured and flow rate control performance of the blow motor 220 can be assisted.

Further, the air inlet portion 217 and the front flow path 211a are formed to have a contained angle of a predetermined size so that the air introduced into the dust sensor through the air inlet portion 217 flows into a curved form while changing its flow direction before reaching the rear flow path 211b. In addition, the rear flow path 211b and the air outlet portion 218 are disposed to have a contained angle of a predetermined size on the basis of the longitudinal direction of the rear flow path 211b and the axial direction of the air outlet portion 218 so that when the air introduced into the rear flow path 211b through the front flow path 211a is discharged to the outside of the case 210 through the air outlet portion 218, the air flows into a curved form while changing its flow direction. By this air flow, change in the flow rate of the air flowing into the case 210 and flowing along the air flow path 211 is further moderated and hence stabilized, with the result that even when sudden change in the flow rate of the outside air occurs, it is possible to secure constant flow rate of the air by utilizing the blow motor 220.

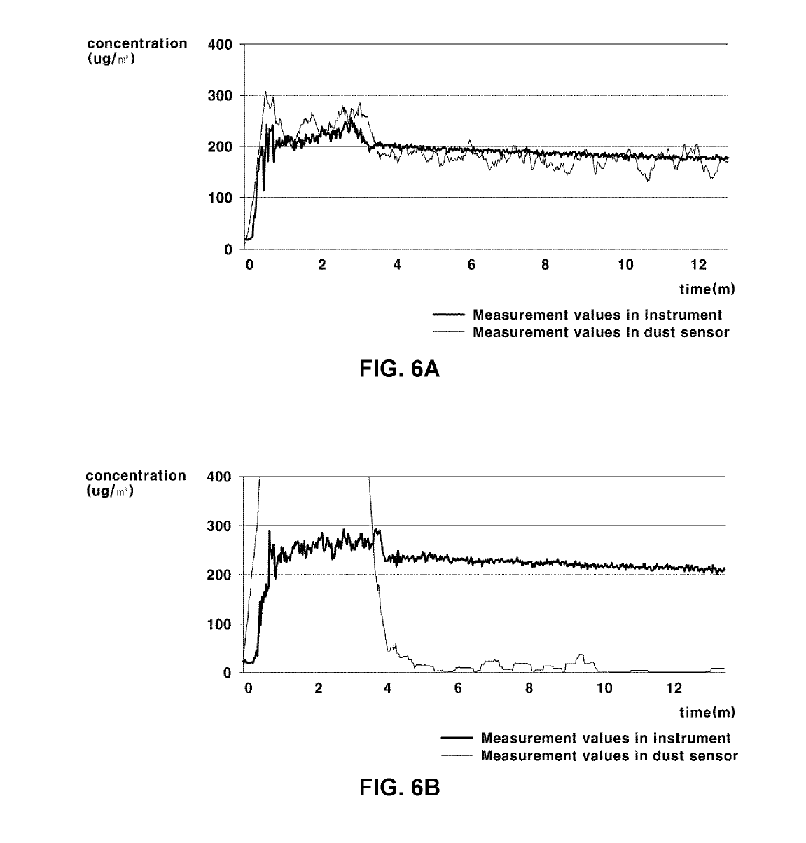

On the other hand, FIG. 6A and FIG. 6B show graphs each of which indicates comparison of performance of measurement before mounting a blow motor in a dust sensor with that after mounting the blow motor in the dust sensor. FIG. 6A shows measurement performance of a light scattering type dust sensor in which the blow motor is disposed and FIG. 6B shows measurement performance of the light scattering type dust sensor to which no blow motor is disposed. Here, it is noted that the dust sensors in FIG. 6A and FIG. 6B have the same configuration condition except whether the blow motor is disposed or not.

As shown in FIG. 6A and FIG. 6B, it can be seen that in a case of the dust sensor to which the blow motor is disposed, the dust sensor represents performance of measuring concentration of dust that is falling within an allowable tolerance range of performance of measuring concentration of dust in a high performance instrument, whereas in the case of the dust sensor to which no blow motor is disposed, there is a large difference in the performance of measuring concentration of dust between the dust sensor and a high performance instrument.

Moreover, advantages of the dust sensor according to an exemplary embodiment of the present invention are now further described as follows:

By installing a blow motor to control flow rate of the air flowing into the case constantly, it is possible to secure air flow having constant flow rate and as a result reliability of measurement of the dust sensor can be secured.

In case where a flow path inside the case of the dust sensor is a straight flow path, it is usually necessary to extend length of the straight flow path to be robust against change in flow rate of the air outside the dust sensor. However, the dust sensor of the present invention can control flow rate of the air in the straight flow path uniformly by utilizing the blow motor and hence stabilize the flow rate of the air without enlarging length of the flow path. Rather, flow rate of the air can be stabilized even when the length of the flow path is shortened, promoting reduction of the size of the dust sensor.

By making in a curved form a flow path of the air flowing into the case through the air inlet portion and then discharging to the outside it is possible to moderate sudden change in flow rate. As a result, stability of the flow rate of the air flowing into the case (particularly, the air passing through the illumination area) is secured so that flow rate control performance of the blow motor can be assisted and the flow rate of the air can be controlled constantly to a constant flow rate even when sudden change in the flow rate occurs.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of predetermined exemplary embodiments of the present invention have been presented for purposes of illustration and description. They are not intended to be exhaustive or to limit the invention to the precise forms disclosed, and obviously ma modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A dust sensor apparatus having flow rate control function comprising:
a case having an air inlet portion through which an air for measurement of concentration of dust flows into the case;
an air flow path for guiding flow of the air introduced into the case through the air inlet portion; and
a blow actuator configured for controlling flow rate of the air flowing into the air flow path to a constant level.

2. The dust sensor apparatus of claim 1, wherein the air flow path includes an illumination area to be irradiated with light for measuring the concentration of the dust and wherein the blow actuator is mounted at a downstream side of the air flow path on a basis of the illumination area to draw the air to be introduced therein through the air inlet portion and then discharge the air to an outside of the case.

3. The dust sensor apparatus of claim 1, wherein the blow actuator includes an impeller for causing air flow by a rotational motion thereof and a casing in which the impeller is rotatably disposed, wherein the casing includes an internal flow path connected to the air flow path and the internal flow path is formed to have a larger diameter than that of the air flow path.

4. The dust sensor apparatus of claim 3, wherein the casing is provided with a discharge port through which the air introduced into the internal flow path is discharged and wherein the discharge port is formed not to be disposed on a same line as a longitudinal direction of the internal flow path.

5. The dust sensor apparatus of claim 2, wherein a plurality of partition walls spaced apart in a longitudinal direction of the air flow path are formed at an upstream side of the air flow path on a basis of the illumination area, wherein the plurality of partition walls are formed such that a first partition wall of the partition walls and a second partition wall closest to the first partition wall protrude toward each other from a first opposite side and a second opposite side and each of the partition walls is formed to shield at least one-half of a cross section of the air flow path.

6. The dust sensor apparatus of claim 1, wherein the air flow path includes an illumination area to be irradiated with light for measuring the concentration of the dust, wherein the blow actuator is mounted at an upstream side of the air flow path on a basis of the illumination area to draw the air to be introduced therein through the air inlet portion and then discharge the air to the illumination area.

7. The dust sensor apparatus of claim 6, wherein the air flow path includes a front flow path connected to the air inlet portion and a rear flow path which is connected to the front flow path and includes the illumination area, wherein the front flow path and the rear flow path are formed to guide the air flow in different directions respectively wherein flow direction of the air introduced therein through the air inlet portion is changed at least once in the air flow path.

8. The dust sensor apparatus of claim 7, wherein the front flow path and the rear flow path are connected to each other to have a predetermined included angle therebetween on a basis of longitudinal directions of the front and rear flow paths.

9. The dust sensor apparatus of claim 7, wherein the air inlet portion is formed in a shape of a pipe protruding from a first surface of the case to an outside of the case and the blow actuator is mounted at an upstream side of the front flow path connected to a downstream side of the air inlet portion.

10. The dust sensor apparatus of claim 7, wherein the front flow path is formed such that a predetermined area at a downstream side of the front flow path on a basis of the position where the blow motor is mounted is inclined with respect to the longitudinal direction of the air inlet portion.

11. The dust sensor apparatus of claim 7, wherein the rear flow path is formed such that an air discharge portion is formed at a downstream side of the rear flow path on a basis of the illumination area, wherein the rear flow path and the air discharge portion have a predetermined included angle on a basis of the longitudinal direction of the rear flow path and an axial direction of the air discharge portion.
